(19) United States
(12) Patent Application Publication
(10) Pub. No.: US 2010/0301517 A1
(43) Pub. Date: Dec. 2, 2010

(54) MOLDING STAMPER AND METHOD FOR FABRICATING SAME

(75) Inventor: YUNG-LUN HUANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/608,164

(22) Filed: Oct. 29, 2009

(30) Foreign Application Priority Data
May 26, 2009 (CN) 200910302647.9

(51) Int. Cl. B29C 33/42; B29C 59/02

(52) U.S. Cl. 264/219; 425/174.4; 425/324.1

(57) ABSTRACT

An exemplary method for fabricating a molding stamper includes the following steps. Firstly, a master mold having microstructures spaced apart from each other is provided. Secondly, a patterned layer is formed on the microstructures, the patterned layer having molding surfaces apart from each other, and being made of a flexible organic material. Thirdly, the master mold is removed from the patterned layer. Finally, a hard coating layer is deposited on the molding surfaces to form a molding stamper.

### BACKGROUND

1. Technical Field

The present disclosure relates to methods for fabricating molding stampers, and particularly, to a method for fabricating a molding stamper having a pattern for shaping a plurality of microlenses, and a molding stamper fabricated by the method.

2. Description of Related Art

A conventional method for making a molding stamper typically includes the following steps: forming a photoresist layer on a substrate; exposing the photoresist layer to light, and developing the photoresist layer using developer; etching the substrate to form a patterned substrate, and removing the photoresist layer; forming a seed layer on the patterned substrate; electroforming a body on the substrate; and separating the electroformed body from the substrate, and stripping the seed layer off the electroformed body to obtain the molding stamper.

However, this method for fabricating the molding stamper includes many steps, and thus the production efficiency of the molding stamper is rather low. In addition, portions of the seed layer may not be completely stripped off from the electroformed body. When this happens, a surface roughness of the molding stamper is increased. This in turn means that the defect rate of final products made using the molding stamper may be unduly high.

Therefore, what is needed is a new method for fabricating a molding stamper, and a molding stamper fabricated by such method, which can overcome the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a flowchart of a method for fabricating a molding stamper according to an exemplary embodiment.

FIGS. 2-6 illustrate successive stages in fabricating the molding stamper according to the method of FIG. 1.

### DETAILED DESCRIPTION

Embodiments will now be described in detail below with reference to the drawings. In this description, unless the context indicates otherwise, it is assumed that a “microstructure” is a structure which has at least one of three dimensions thereof in the range from about 0.1 micrometers to about 999 micrometers. Similarly, unless the context indicates otherwise, a “microlens” is assumed to have a similar meaning.

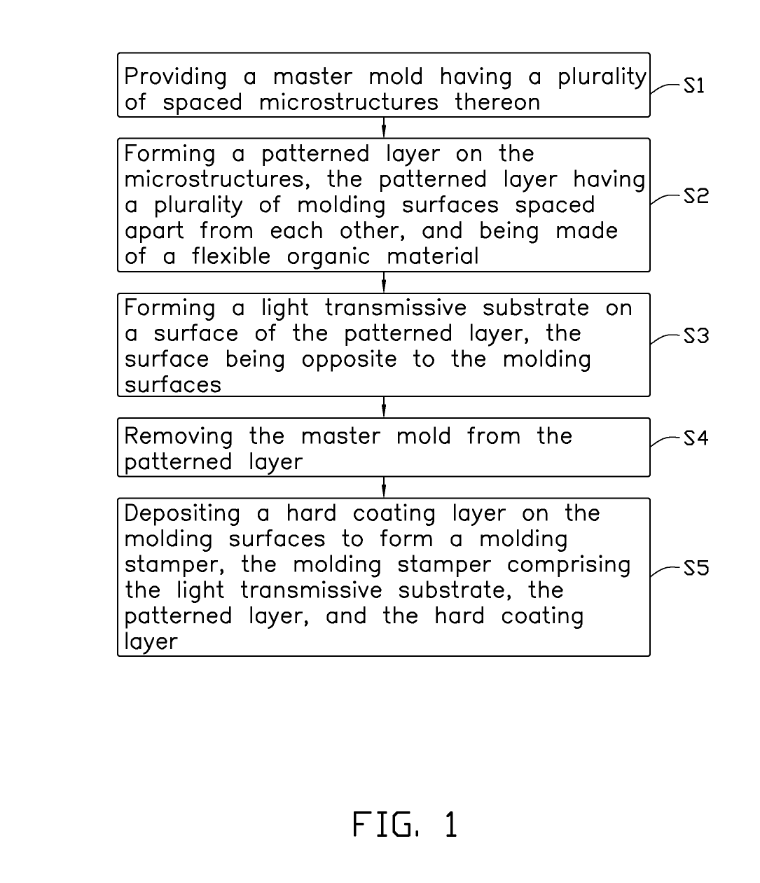

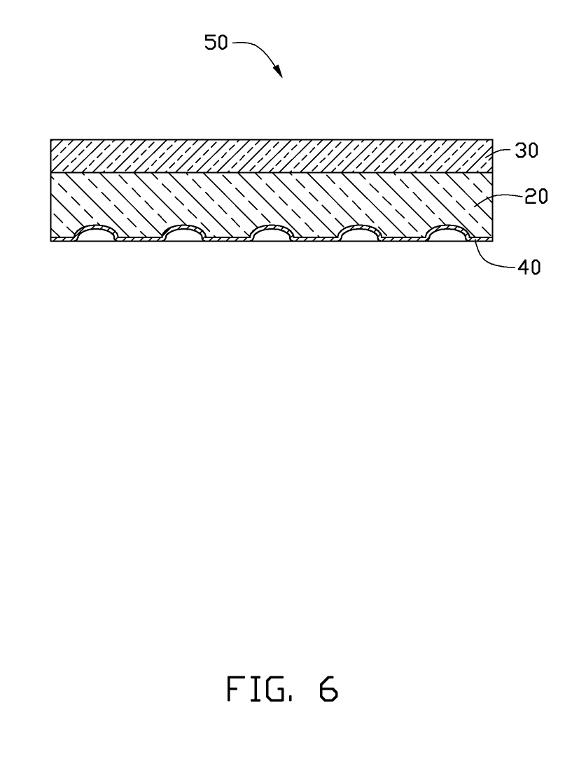

Referring to FIG. 1, a method for fabricating a molding stamper 50 (see FIG. 6), in accordance with an exemplary embodiment, includes the following steps: step S1, providing a master mold having a plurality of spaced microstructures thereon; step S2, forming a patterned layer on the microstructures, the patterned layer having a plurality of molding surfaces spaced apart from each other, and being made of a flexible organic material; step S3, forming a light transmissive substrate on a surface of the patterned layer, the surface being opposite to the molding surfaces; step S4, removing the master mold from the patterned layer; and step S5, depositing a hard coating layer on the molding surfaces to form a molding stamper, the molding stamper comprising the light transmissive substrate, the patterned layer, and the hard coating layer.

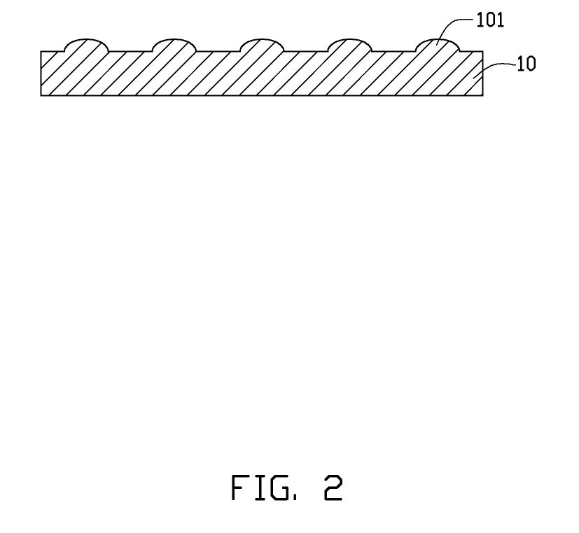

In step S1, referring also to FIG. 2, a master mold 10 is firstly provided. The master mold 10 includes a plurality of microstructures 101 spaced apart from each other. In the present embodiment, the microstructures 101 are made by ultra-precision cutting, and the microstructures 101 are protrusions. In other embodiments, the microstructures 101 may instead be made by electron beam lithography, laser lithography, particle beam lithography, etc; and the microstructures 101 may instead be recesses.

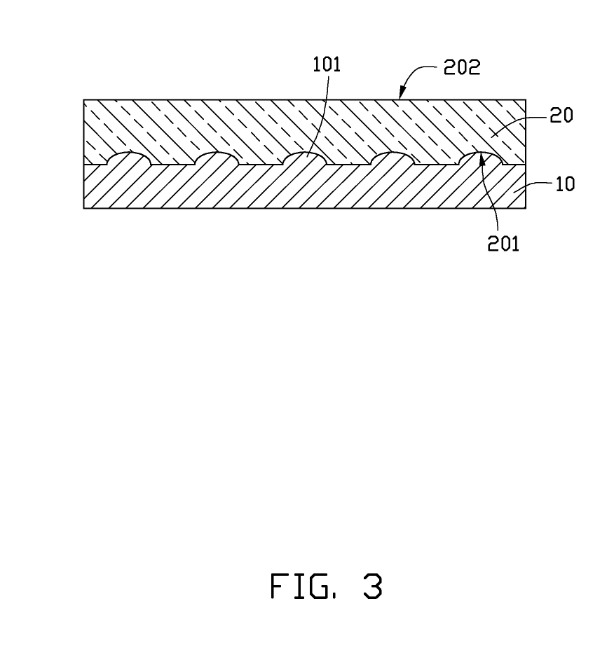

In step S2, referring to FIG. 3, a patterned layer 20 is formed on the microstructures 101 by pouring a flexible organic material over the microstructures 101, and curing the flexible organic material. The patterned layer 20 includes a plurality of molding surfaces 201 at a bottom side thereof, and a surface 202 at an opposite top side thereof. The molding surfaces 201 are spaced apart from each other, and are configured for shaping microlenses (not shown). The molding surfaces 201 are formed by transferring the microstructures 101 onto the flexible organic material, and correspondingly are recesses. In the present embodiment, the patterned layer 20 is made of polydimethyl siloxane (PDMS). In alternative embodiments, the molding surfaces 201 may instead be protrusions. In other alternative embodiments, the patterned layer 20 may instead be made of polymethyl methacrylate (PMMA), polycarbonate (PC), etc.

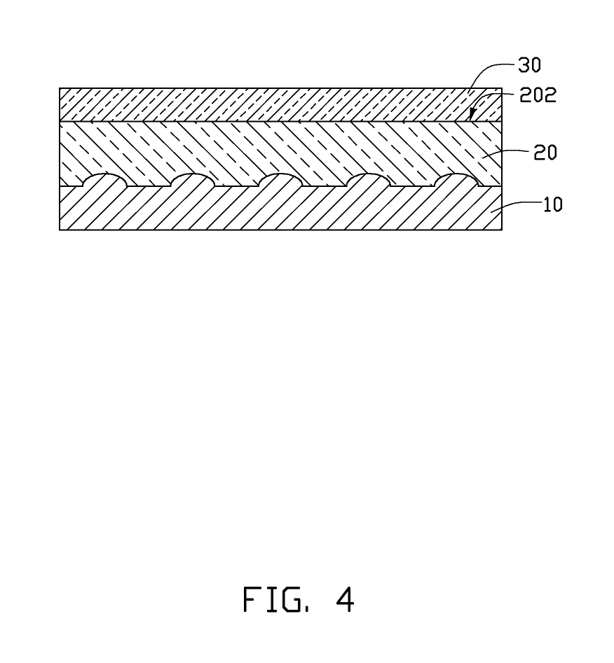

In step S3, referring to FIG. 4, a light transmissive substrate 30 is formed on the surface 202 of the patterned layer 20. The light transmissive substrate 30 is configured for supporting the patterned layer 20 to facilitate a higher bearing strength of the mold stamper 50.

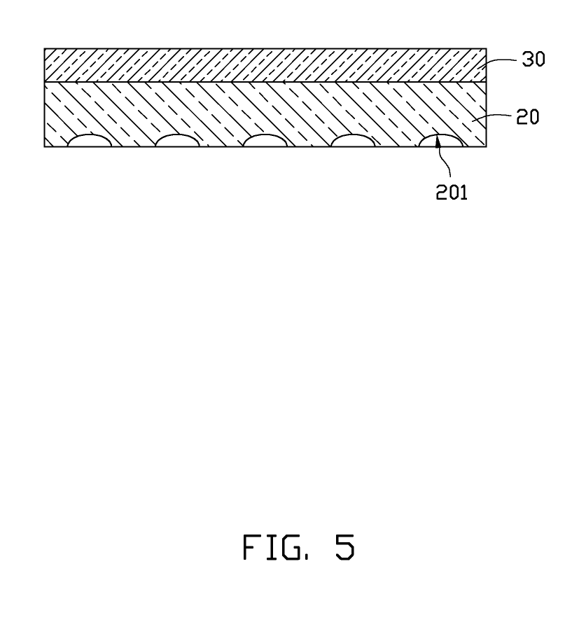

In step S4, referring to FIG. 5, the master mold 10 is removed from the patterned layer 20.

In step S5, referring to FIG. 6, a hard coating layer 40 is deposited on the molding surfaces 201 and on a bottom surface of the patterned layer 20 that surrounds the molding surfaces 201, thereby forming the molding stamper 50. The molding stamper 50 includes the patterned layer 20, the light transmissive substrate 30, and the hard coating layer 40. The hard coating layer 40 is configured for enhancing the hardness of the molding surfaces 201. In the present embodiment, the hard coating layer 40 is deposited by radio frequency magnetron sputtering, and the hard coating layer 40 is made of silicon dioxide. In other embodiments, the hard coating layer 40 may instead be made of silicon, silicon carbide, diamond-like carbon, etc.

When the hard coating layer 40 is being deposited, a bombardment temperature on a silicon dioxide sputtering target (not shown) is in a range from about 160 degrees Centigrade to about 200 degrees Centigrade. A pressure in a vacuum cavity (not shown) receiving the combined patterned layer 20 and light transmissive substrate 30 therein is in a range from about 0.013332 pascal (Pa) to about 0.13332 Pa. The vacuum cavity is preferably held at room temperature for preventing the molding surfaces 201 from deforming.

Because the molding stamper 50 is fabricated by the transfer imprint of the master mold 10, the method for fabricating the molding stamper 50 is simple, thereby enhancing the production efficiency of the molding stamper 50. In addition, the method for fabricating the molding stamper 50 does not require removal of any seed layer from the molding surfaces 201. Thus surface roughness problems associated with conventional molding stampers are circumvented. Furthermore, the hard coating layer 40 can enhance the hardness of the molding surfaces 20. Accordingly, the molding stamper 50 has a higher wear resistance.

In alternative embodiments, step S3 may instead be performed after step S4 and before step S5. In other alternative embodiments, step S3 may instead be performed after step S5. In still other alternative embodiments, the step S3 may instead be omitted.

While certain embodiments have been described and exemplified above, various other embodiments will be apparent to those skilled in the art from the foregoing disclosure. The disclosure is not limited to the particular embodiments described and exemplified, but is capable of considerable variation and modification without departure from the scope and spirit of the appended claims.

What is claimed is:

1. A method for fabricating a molding stamper, the method comprising:
providing a master mold having a plurality of microstructures thereon, the microstructures spaced apart from each other;
forming a patterned layer on the microstructures, the patterned layer having a plurality of molding surfaces spaced apart from each other, and being made of flexible organic material;
removing the master mold from the patterned layer; and
depositing a hard coating layer on the molding surfaces to form a molding stamper.

2. The method of claim 1, wherein the microstructures of the master mold are made by a method selected from the group consisting of ultra-precision cutting, electron beam lithography, laser lithography and particle beam lithography.

3. The method of claim 1, wherein the hard coating layer is deposited by radio frequency magnetron sputtering.

4. The method of claim 3, wherein the hard coating layer is comprised material selected from the group consisting of silicon dioxide, silicon, silicon carbide and diamond-like carbon.

5. The method of claim 4, wherein the hard coating layer is comprised of silicon dioxide, and during the depositing of the hard coating layer, a bombardment temperature on a silicon dioxide sputtering target is in a range from 160 degrees Centigrade to 200 degrees Centigrade, a pressure in a vacuum cavity receiving the patterned layer therein is in a range from 0.013332 Pa to 0.13332 Pa, and the vacuum cavity is at room temperature.

6. The method of claim 1, further comprising forming a light transmissive substrate on a surface of the patterned layer, the surface being on a side of the patterned layer opposite to the side of the patterned layer having the molding surfaces.

7. A molding stamper comprising:
a patterned layer, the patterned layer comprising a plurality of molding surfaces at one side thereof and a surface at an opposite side thereof, the molding surfaces being spaced apart from each other, the patterned layer being made of flexible organic material;
a light transmissive substrate attached to the surface of the patterned layer; and
a hard coating layer deposited on the molding surfaces.

8. The molding stamper of claim 7, wherein the flexible organic material is comprised of material selected from the group consisting of polydimethyl siloxane (PDMS), polymethyl methacrylate (PMMA) and polycarbonate (PC).

9. The molding stamper of claim 7, wherein the hard coating layer is comprised of material selected from the group consisting of silicon dioxide, silicon, silicon carbide and diamond-like carbon.

10. A molding stamper comprising:
a patterned layer, the patterned layer comprising a plurality of molding surfaces spaced apart from each other, the patterned layer being made of flexible organic material; and
a hard coating layer deposited on the molding surfaces.

11. The molding stamper of claim 10, wherein the flexible organic material is comprised of material selected from the group consisting of polydimethyl siloxane (PDMS), polymethyl methacrylate (PMMA) and polycarbonate (PC).

12. The molding stamper of claim 10, wherein the hard coating layer is comprised of material selected from the group consisting of silicon dioxide, silicon, silicon carbide and diamond-like carbon.
